(19) United States
(12) Patent Application Publication
(10) Pub. No.: US 2010/0329221 A1
(43) Pub. Date: Dec. 30, 2010

(54) Transmission Mode Control Method And Communication Terminal Device

(75) Inventor: Hiroyuki NAKANO, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: Fujitsu Limited, Kawasaki-shi (JP)

(21) Appl. No.: 12/880,714

(22) Filed: Sep. 13, 2010

Related U.S. Application Data
(63) Continuation of application No. PCT/JP2008/055365, filed on Mar. 24, 2008.

(51) Int. Cl. H04J 3/00

(52) U.S. Cl. 370/336

(57) ABSTRACT

A transmission scheme controlling method performed by a radio communication device capable of performing radio communication with a different radio communication device in a transmission scheme in which a collision with another transmitting signal may occur is characterized by comprising the steps of: in response to communication requests collected from other radio communication devices, judging whether communication based on time slots is performed; when it is judged that the communication based on the time slots is performed, performing processing for assigning the time slots according to the collected communication requests; and when it is judged that the communication based on the time slots is not performed, performing the ratio communication with the different radio communication device in the transmission scheme.

### CROSS-REFERENCE TO RELATED APPLICATIONS

This is a continuation of Application, filed under 35 U.S.C. §111(a) of International Application PCT/JP2008/055365, filed on Mar. 24, 2008, the contents of which are herein wholly incorporated by reference.

### FIELD

The present invention relates to a communication terminal device in a communication network.

### BACKGROUND

A plurality of communication terminal devices (which will hereinafter be referred to as nodes) performs communication multiplexing in an ad hoc network, in which case a carrier sense multiple access with collision avoidance (Carrier Sense Multiple Access with Collision Avoidance (CSMA/CA)) method is frequently used. This is because an occurrence probability of a collision in communication is low, the control is easy to conduct, and a configuration of the device is simple in the case of a small number of wireless communication terminal devices.

In the ad hoc network, the wireless communications can be performed by transmitting and receiving radio signals between the plurality of wireless communication terminal devices without via an access point. Within the ad hoc network, with movement of the wireless communication terminal device, the wireless communication terminal device might be isolated.

The CSMA/CA method is a method of avoiding the collision when the plurality of wireless communication terminal devices performs the communications through the same communication channel. Each wireless communication terminal device checks that the communication channel remains unoccupied for a fixed period of time or longer and thus transmits data. A period of time till the data is transmitted since the last communication has been conducted is the time obtained by adding a random length of time to a predetermined period of time. This contrivance prevents, after the just-anterior communication, the collision between the signals that are transmitted simultaneously by the plurality of wireless communication terminal devices after the fixed period of time. The CSMA/CA method is classified into an asynchronous communication method.

[Patent document 1] Japanese Patent Laid-Open Publication No.2005-295400
[Patent document 2] Japanese Patent Laid-Open Publication No.2007-67654
[Patent document 3] Japanese Patent Laid-Open Publication No.2002-77978
[Patent document 4] Japanese Patent Laid-Open Publication No.2002-77979

### SUMMARY

According to an aspect of the invention, a transmission mode control method executed by a wireless communication device capable of performing wireless communications with other wireless communication devices in a transmission mode where a collision with other transmission signals might occur, includes determining whether or not communications according to a timeslot are carried out in response to communication requests collected from a plurality of other wireless communication devices; and executing a timeslot allocation process according to the collected communication requests when determining that the communications according to the timeslot are carried out, and performing the wireless communications with the other wireless communication devices in the transmission mode when determining that the communications according to the timeslot are not carried out.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating an example of an outline of a configuration of a communication system.

FIG. 2 is a block diagram illustrating functions of a node. FIG. 3 is a diagram illustrating an example of how a timeslot allocation desire check packet is transmitted.

FIG. 4 is a diagram illustrating an example of a transmission timing of the timeslot allocation desire check packet.

FIG. 5 is a diagram illustrating an example of how a timeslot allocation request packet is transmitted.

FIG. 6 is a diagram illustrating an example of the transmission timing of the timeslot allocation request packet.

FIG. 7 is a diagram illustrating an example of how the timeslot allocation request packet is transmitted.

FIG. 8 is a diagram illustrating an example of the transmission timing of the timeslot allocation request packet.

FIG. 9 is a diagram illustrating an example of how a timeslot allocation result notification packet is transmitted.

FIG. 10 is a diagram illustrating an example of the transmission timing of the timeslot allocation result notification packet.

FIG. 11 is a diagram illustrating an example of the timeslot allocation result notification packet.

FIG. 12 is a diagram illustrating a state of allocating timeslots to respective nodes.

FIG. 13 is a diagram illustrating a state where the node allocated the timeslot performs communications.

FIG. 14 is a diagram illustrating an example of how a timeslot allocation desire check packet is transmitted in a TDMA mode.

FIG. 15 is a diagram illustrating an example of the transmission timing of the timeslot allocation desire check packet is transmitted in the TDMA mode.

FIG. 16 is a diagram illustrating an example of simultaneously transmitting the timeslot allocation request packets.

FIG. 17 is a diagram illustrating an example of the transmission timing when simultaneously transmitting the timeslot allocation request packets.

FIG. 18 is a diagram illustrating an example of a state where a new timeslot allocation result notification packet is not transmitted.

FIG. 19 is a diagram illustrating an example of the timing in the state where the new timeslot allocation result notification packet is not transmitted.

FIG. 20 is a diagram illustrating an example when the timeslot allocation request packet is retransmitted.

FIG. 21 is a diagram illustrating an example of the transmission timing when the timeslot allocation request packet is retransmitted.

FIG. 22 is a diagram illustrating an example when the timeslot allocation request packet is retransmitted.

FIG. 23 is a diagram illustrating an example of the transmission timing when the timeslot allocation request packet is retransmitted.

FIG. 24 is a diagram illustrating an example of how the timeslot allocation result notification packet is transmitted.

FIG. 25 is a diagram illustrating an example of the transmission timing of the timeslot allocation result notification packet.

FIG. 26 is a diagram illustrating an example when the timeslot allocation request packets are simultaneously transmitted again.

FIG. 27 is a diagram illustrating an example of the transmission timing when the timeslot allocation request packets are simultaneously transmitted again.

FIG. 28 is a whole flowchart (1) of the node.

FIG. 28 is a whole flowchart (2) of the node.

FIG. 30 is a whole flowchart (3) of the node.

FIG. 31 is a whole flowchart (4) of the node.

FIG. 32 is a whole flowchart (5) of the node.

FIG. 33 is a whole flowchart (6) of the node.

FIG. 34 is a whole flowchart (7) of the node.

FIG. 35 is a whole flowchart (8) of the node.

FIG. 36 is a whole flowchart (9) of the node.

FIG. 37 is a whole flowchart (10) of the node.

FIG. 38 is a whole flowchart (11) of the node.

FIG. 39 is a whole flowchart (12) of the node.

FIG. 40 is a diagram illustrating linkup of layers.

### DESCRIPTION OF EMBODIMENTS

An embodiment will hereinafter be described with reference to the drawings. A configuration in the embodiment is an exemplification, and the present invention is not limited to the configuration in the embodiment disclosed herein.

### Embodiment

### (Time Division Multiple Access Method)

A Time Division Multiple Access (TDMA) method is a method of giving a transmission opportunity on a per-wireless-communication-terminal basis by allocating, to each wireless communication terminal, a period of transmission-enabled time (time interval) (which will hereinafter be also referred to as a timeslot) into which a frame (signal) is divided at an interval of a fixed period of communication time in a system where a plurality of wireless communication terminal devices is connected via a common communication path. In the TDMA method, each wireless communication terminal device is given the opportunity of transmitting data at the interval of the fixed time.

The TDMA method has high usage efficiency of a communication band as compared with a CSMA/CA method (which is a transmission mode in which a collision with other transmission signals might occur) by allocating the timeslots to nodes each having transmission data.

(Configuration)

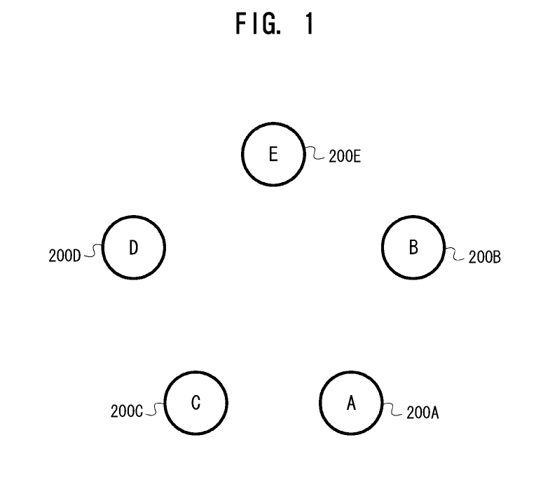

FIG. 1 is a diagram illustrating an example of an outline of a configuration of a communication system in the embodiment. The communication system in the embodiment includes five wireless communication terminal devices (nodes 200A-200E). Each wireless communication terminal device exists in a location enabling the self-device to perform communications with at least one single wireless communication terminal device. Herein, there are the five wireless communication terminal devices, which is an exemplification, but the number of the wireless communication terminal devices is not limited to “5”. Further, the respective wireless communication terminal devices in the communication system of the embodiment do not fixedly exist, but the number of wireless communication terminal devices might be incremented and decremented when further subscriptions and withdrawals are made.

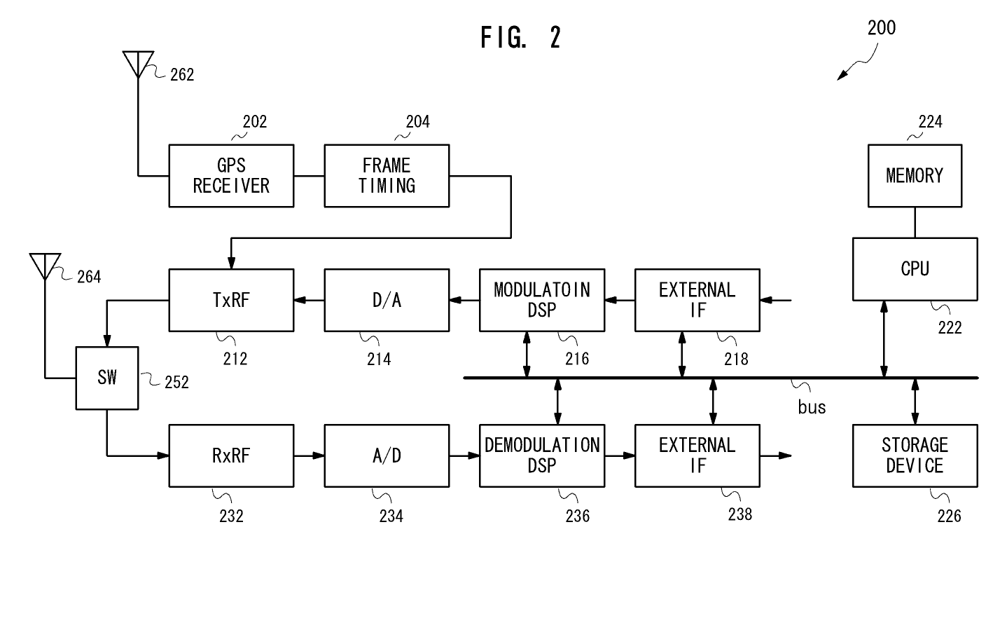

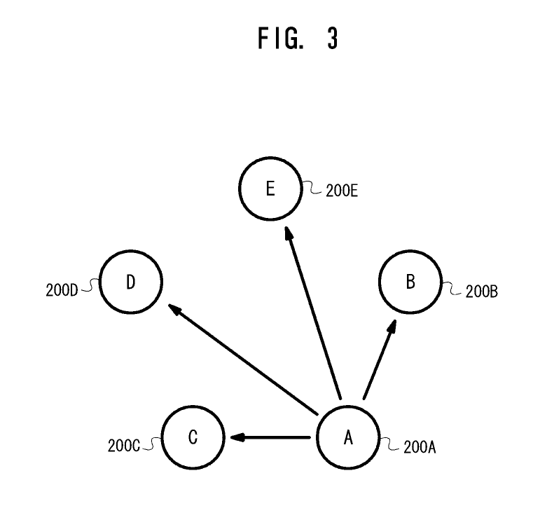

FIG. 2 illustrates a function block diagram of the wireless communication terminal device (Node) in the embodiment.

The wireless communication terminal device 200 includes an antenna 262 for Global Positioning System (GPS), a GPS receiver unit 202, a frame timing (Frame Timing) unit 204, a radio frequency (RF) transmission unit (TxRF) 212, a digital/analog (Digital/Analog, D/A) converting unit 214, a digital signal processor (DSP) unit 216 for modulation, a transmission-side external interface (Interface, IF) unit 218, a radio frequency receiving unit (RxRF) 232, an analog/digital (Analog/Digital, A/D) converting unit 234, a DSP unit 236 for demodulation, a reception-side external interface 238, an antenna 264 for transmission and reception, a switch (Switch, SW) unit 252, a central processing unit (CPU) 222, a memory 224 and a storage device 226.

The modulation DSP unit 216, the transmission-side external IF 218, the demodulation DSP 236, the reception-side external IF 238, the CPU 222 and the storage device 226 are connected to a bus.

The GPS receiver unit 202 receives a clock signal from a GPS satellite via the GPS antenna 262. The frame timing unit 204 acquires, based on the clock signal received by the GPS receiver unit 202, precise time information. The precise time information may be acquired not by using the GPS system but by other methods. The frame timing unit 204 can function as a signal generating unit.

The frame timing unit 204, by using the precise time information, generates a timing signal for synchronizing with the timeslot that is time-sliced on the per-predetermined-time basis and transmits the timing signal to the RF transmission unit 212. The timing signal is, when transmitting the data in a TDMA mode, used in the case of transmitting a timeslot allocation request packet in a CSMA/CA mode within the timeslot allocated to a main node.

The RF transmission unit 212, the digital/analog converting unit 214, the modulation DSP unit 216 and the transmission-side external IF 218 function as a transmitting unit.

The modulation DSP unit 216 modulates the data that is inputted from the transmission-side external IF 218 and the data that is arithmetically processed by the CPU 222 into transmission digital signals. The digital/analog converting unit 214 converts the transmission digital signals modulated by the modulation DSP unit 216 into transmission analog signals. The RF transmission unit 212 modulates the transmission analog signals into a radio frequency (RF) from a baseband frequency (BF). Further, the RF transmission unit 212 determines a signal transmission timing based on a timing signal sent from the frame timing unit 204 according to the necessity. The thus-modulated transmission analog signals are transmitted via the switch unit 252 and the transmitting/receiving antenna 264.

The RF reception unit 232, the analog/digital converting unit 234, the demodulation DSP 236 and the reception-side external IF 238 function as a receiving unit.

The signals received by the transmitting/receiving antenna 264 are inputted to the RF reception unit 232 via the switch unit 252. The RF reception unit 232 modulates the received signals into the baseband frequency (GF) from the radio frequency (RF). The analog/digital converting unit 234 converts the reception analog signals modulated by the RF reception unit 232 into reception digital signals. The demodulation DSP 236 demodulates the reception analog signals. The demodulated data is inputted to and processed by the reception-side external IF 238 and the CPU 222.

The CPU 222 can function as a control unit which controls the respective function units and as an arithmetic unit which processes information of each packet. The CPU 222 can generate a timeslot allocation desire check packet, a timeslot allocation request packet, a timeslot allocation result notification packet, a back-off count threshold value excess notification packet and other packets. The CPU 222 can allocate the timeslot to each node on the basis of the received timeslot allocation request packet. The CPU 222 can function as a generating unit which generates the packets. The CPU 222 can function as a variety of timers.

The storage device 226 can be stored with the transmission/reception data, periods of standby time (predetermined time) of the variety of timers, a back-off processing count, a threshold value of the back-off processing count, etc.

### Operational Example

### <Whole Operation>

An outline of the whole operation in the embodiment will hereinafter be described.

The node operating as the main node performs the timeslot desire check with respect to peripheral nodes in the CSMA/CA mode. The timeslot is defined as the transmission-enabled time (which is also termed a transmission period) allocated on the per-node basis, which is used in a TDMA (Time Division Multiple Access) mode. The peripheral node, in the case of desiring the timeslot allocation, makes a timeslot allocation request. The main node allocates the timeslot used in the TDMA mode on the basis of the timeslot allocation request. The main node notifies the peripheral node of a result of the timeslot allocation. Each node allocated the timeslot performs the communications according to the allocation in the TDMA mode.

FIG. 3 is a diagram illustrating an example of how the timeslot desire check packet is transmitted.

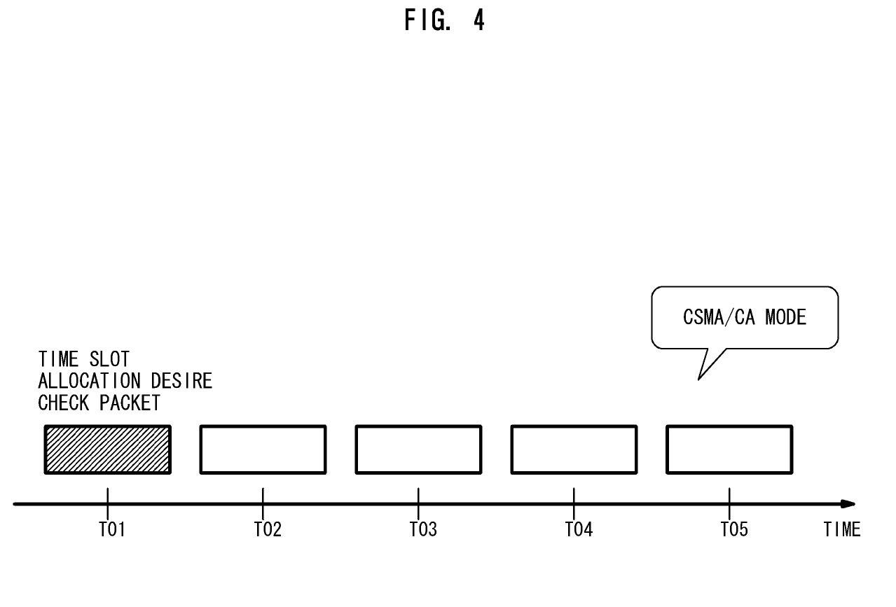

FIG. 4 is a diagram illustrating an example of the transmission timing of the timeslot desire check packet.

The node 200A having the transmission data to other nodes transmits the timeslot (Time Slot) allocation desire check packet to the nodes peripheral to the node 200A at a certain point of timing T01 in the CSMA/CA mode. The timing T01 can be set to a predetermined timing that goes round at a predetermined cycle, i.e., any one of the timings selected by the node 200A. At this time, if the packet is transmitted with no collision, the node 200A operates as the main node. Other nodes respectively receive the timeslot allocation desire check packets from the node 200A.

Note that the node 200A can transmit the timeslot allocation desire check packet under another condition. For example, this is exemplified by a case of detecting that the predetermined timing is reached, a case of detecting a predetermined number of wireless-communication-enabled nodes existing on the periphery, and so on.

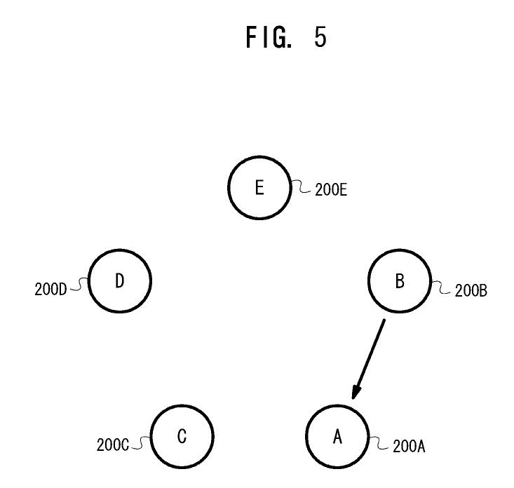

FIG. 5 is a diagram illustrating an example of how the timeslot allocation request packet is transmitted.

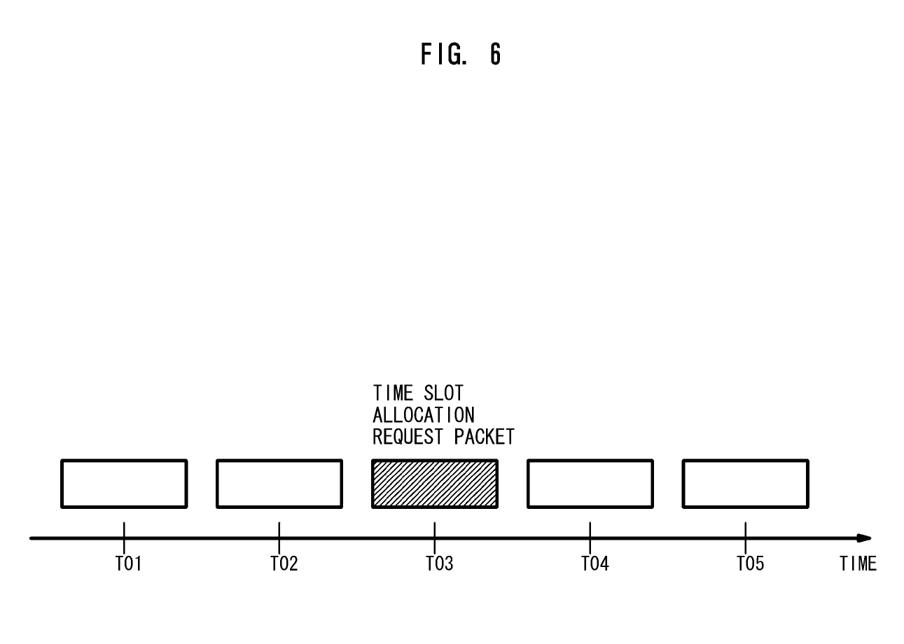

FIG. 6 is a diagram illustrating an example of the transmission timing of the timeslot allocation request packet.

The node 200B has, it is assumed, the data that is transmitted to other nodes. The node 200B receiving the timeslot allocation desire check packet from the node 200A transmits the timeslot allocation request packet to the node 200A at a certain point of timing T03 in the CSMA/CA mode. The node 200A receives the timeslot allocation request packet from the node 200B. At this timing T03, any packets are not transmitted from other nodes, and hence the node 200A can receive the timeslot allocation request packet from the node 200B.

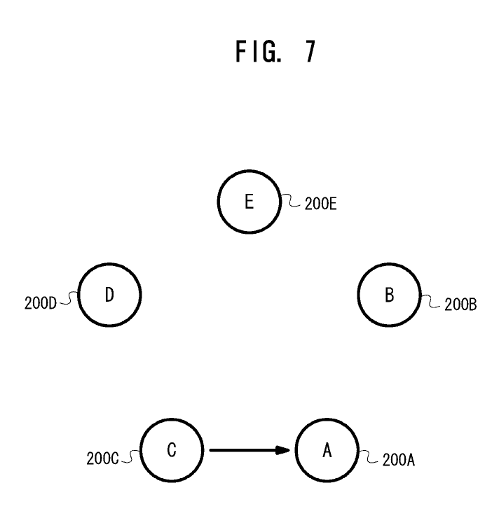

FIG. 7 is a diagram illustrating how the timeslot allocation request packet is transmitted.

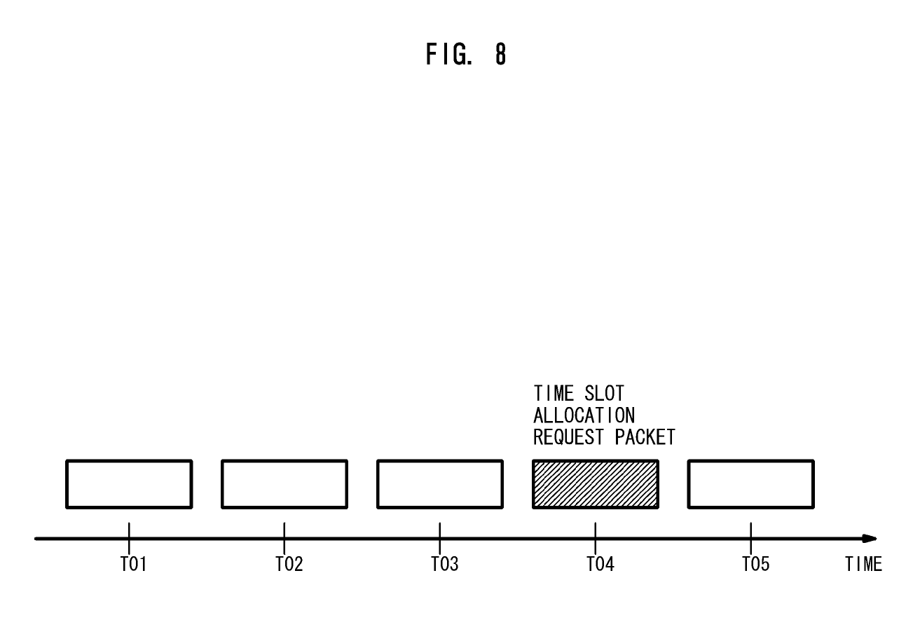

FIG. 8 is a diagram illustrating an example of the transmission timing of the timeslot allocation request packet.

Similarly to the node 200B, the node 200C has, it is assumed, the data that is transmitted to other nodes. The node 200C receiving the timeslot allocation desire check packet from the node 200A transmits the timeslot allocation request packet to the node 200A at a certain point of timing T04 in the CSMA/CA mode. The node 200A receives the timeslot allocation request packet from the node 200C. At this timing T04, any packets are not transmitted from other nodes, and therefore the node 200A can receive the timeslot allocation request packet from the node 200C.

Neither the node 200D nor the node 200E has the data that is transmitted to other nodes. At this time, the node 200D and the node 200E do not transmit the timeslot allocation request packet for the timeslot allocation desire check packet sent from the node 200A. In other examples, however, for the prospective data transmission, the timeslot allocation request packet can be also transmitted.

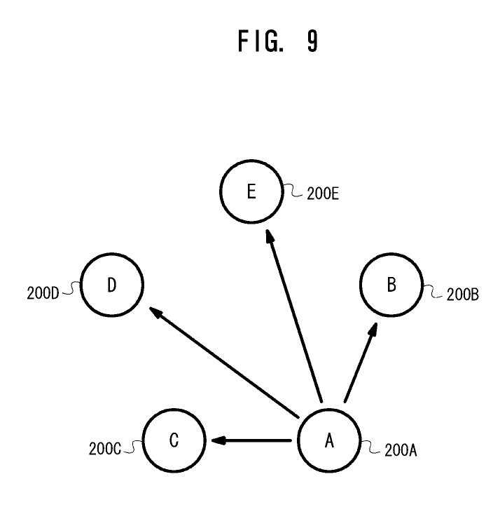

FIG. 9 is a diagram illustrating an example of how the timeslot allocation result notification packet is transmitted.

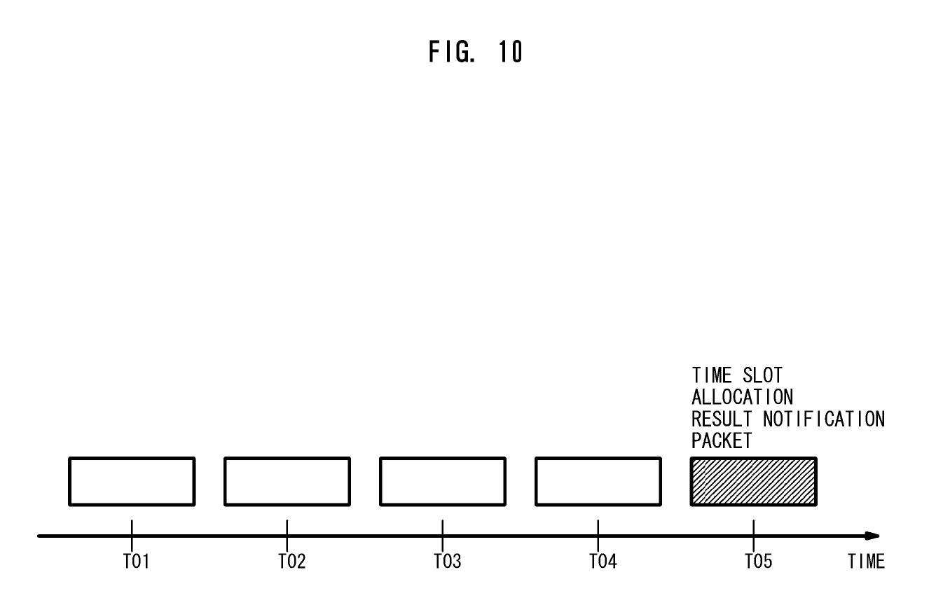

FIG. 10 is a diagram illustrating an example of the transmission timing of the timeslot allocation result notification packet.

The node 200A, after transmitting the timeslot allocation desire check packet at the timing T01, stands by for receiving the timeslot allocation request packets from other nodes for a predetermined period of time. After an elapse of the predetermined time, the node 200A allocates the timeslots on the basis of the timeslot allocation request packets received during the standby. The main node allocates the timeslot also to the self-node. Herein, the timeslots are allocated to the three nodes, i.e., the node 200A, the node 200B and the node 200C. A result (data) of the timeslot allocation can be stored in the storage device 226.

The node 200A, after allocating the timeslots, transmits the timeslot allocation result notification packet to other nodes.

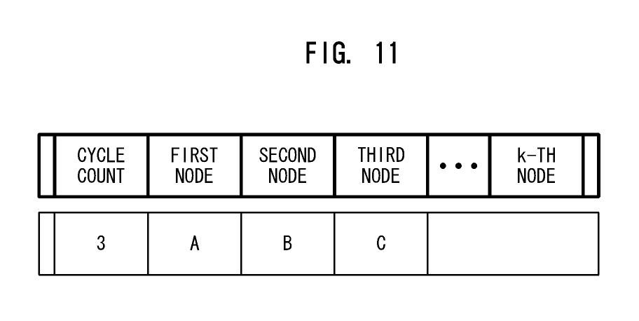

FIG. 11 is a diagram illustrating an example of the timeslot allocation result notification packet.

The timeslot allocation result notification packet contains a cycle count and names of the nodes allocated the timeslots. The cycle count is information representing the number of nodes shared with a series of timeslots. The node names are described in the timeslot allocation sequence. In the example of FIG. 11, the cycle count is [3] because of the timeslots being shared among the three nodes, i.e., the node 200A, the node 200B and the node 200C. Further, the timeslots are allocated in the sequence such as the node 200A, the node 200B and the node 200C, and hence the node names are described, in which [A] is given to the first node, [B] is given to the second node, and [C] is given to the third node in this sequence. It should be noted that the cycle count (which is one example of the information on the cycle of the timeslots usable for the transmission through the allocation) can take a value larger than the number of nodes including the self-node that transmit the timeslot allocation request packets. Though not-yet-allocated timeslots occur, a period for which the data is not transmitted is ensured, and the transmission process according to the CSMA/CA can be executed during this period. Especially the node, which has moved afterward, can make the timeslot allocation request by using this period and can perform the wireless communications with another node in the CSMA/CA.

Further, if a total of the nodes including the self-node, which transmit the timeslot allocation request packets, is less than a predetermined count (e.g., 1), the communications can be also performed in the CSMA/CA method in a status quo without shifting to the TDMA method. This is because there is a low possibility of the collision. Each node can be notified of the purport of not shifting by transmitting none of the timeslot allocation result notification packet or by including, in the timeslot allocation result notification packet, a signal for notifying that the operation should be done in the CSMA/CA mode without conducting the timeslot allocation.

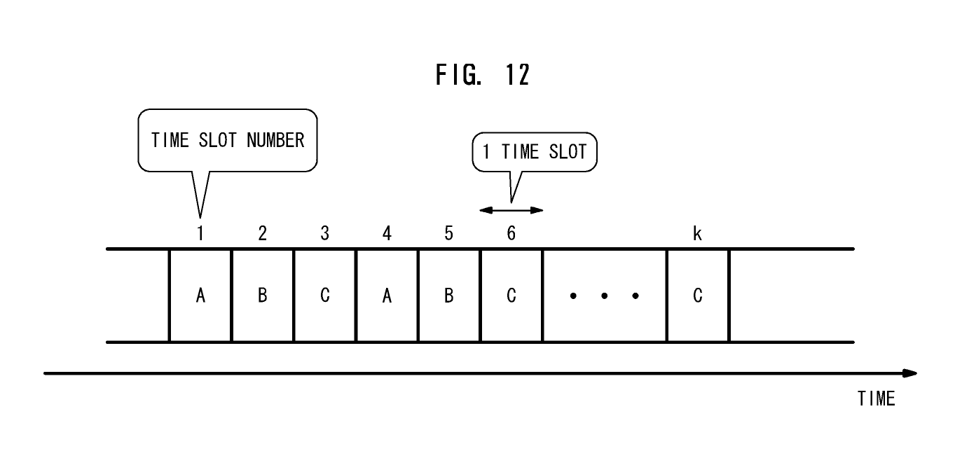

FIG. 12 is a diagram illustrating a status where the timeslots are allocated to the respective nodes.

As depicted in FIG. 12, the node 200A, the node 200B and the node 200C participate in the communications, whereby the timeslots are allocated cyclically to the three nodes.

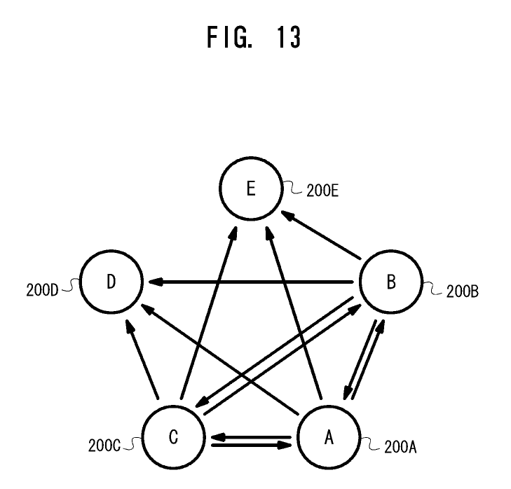

FIG. 13 is a diagram illustrating a status in which the nodes allocated the timeslots perform the communications.

When the timeslot allocation result notification packet is transmitted, each node, upon receiving this packet, transitions to the TDMA mode from the CSMA/CA mode.

Each of the node 200A, the node 200B and the node 200C transmits the data to other nodes within the allocated timeslot. The node D and the node E allocated none of the timeslots can not transmit the data in principle.

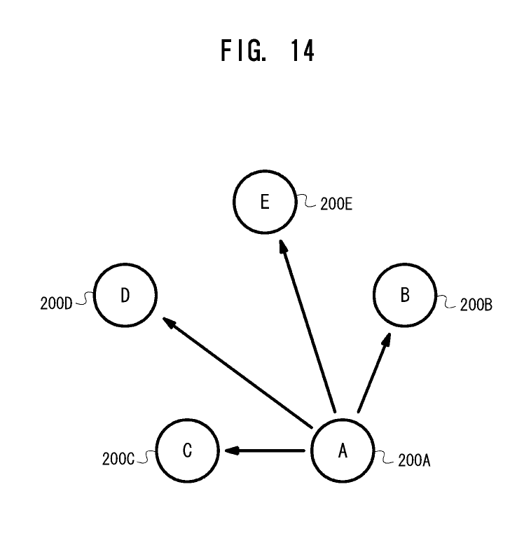

FIG. 14 is a diagram illustrating an example of how the timeslot allocation desire check packet is transmitted in the TDMA mode.

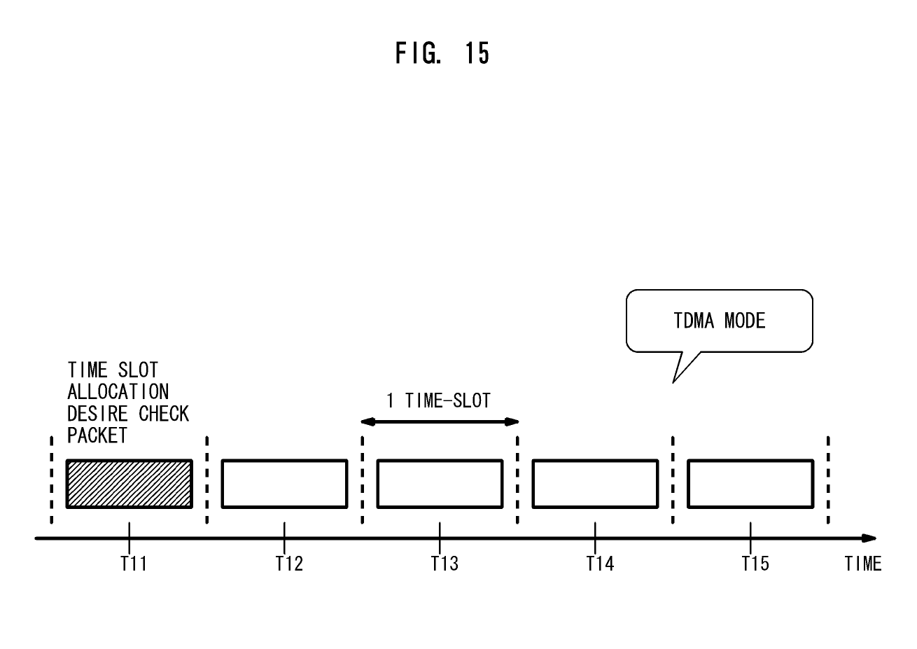

FIG. 15 is a diagram illustrating an example of the transmission timing of the timeslot allocation desire check packet in the TDMA mode.

The node 200A defined as the main node in the process of performing the communications with the node 200B and the node 200C in the TDMA mode, transmits the timeslot allocation desire check packets to the peripheral nodes by use of its own timeslot. The peripheral nodes other than the node 200A, the node 200B and the node 200C can recognize that the node 200A, the node 200B and the node 200C execute the communications in the TDMA mode by monitoring the communication statuses. Further, the peripheral node can recognize that the timeslot allocation desire check packet is transmitted within the timeslot allocated to the node 200A.

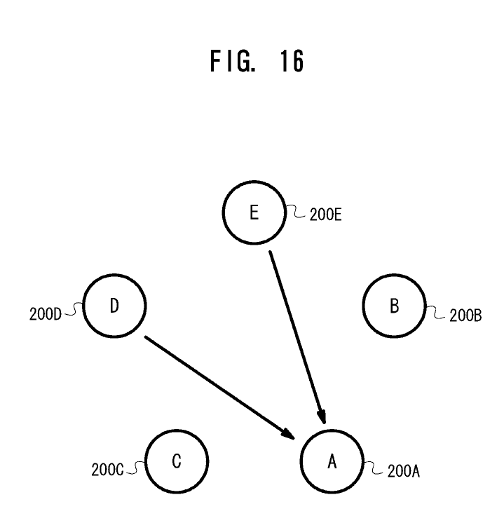

FIG. 16 is a diagram illustrating an example of a case of simultaneously transmitting the timeslot allocation request packets.

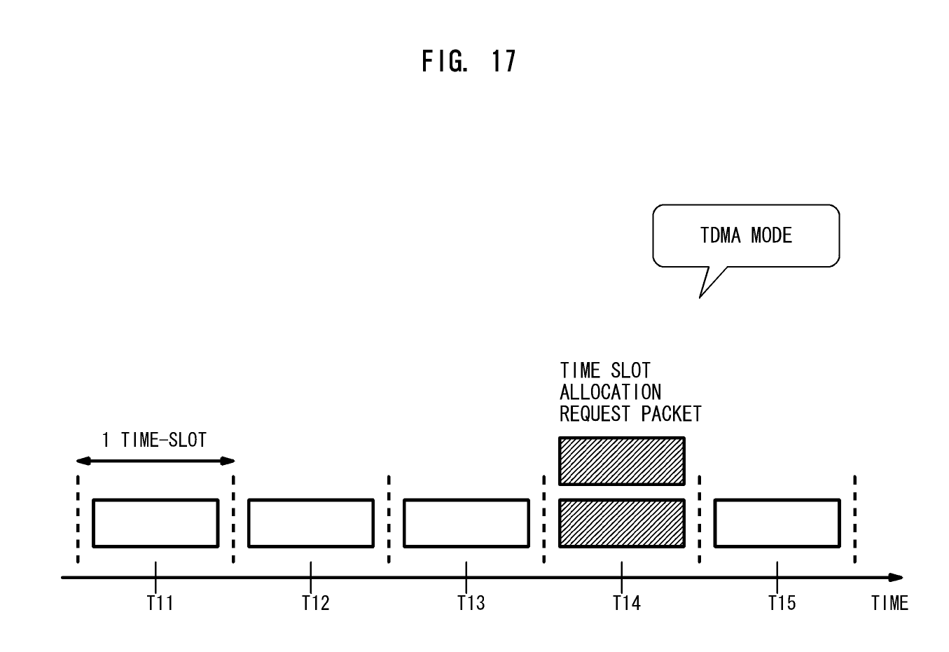

FIG. 17 is a diagram illustrating an example of the transmission timing in the case of simultaneously transmitting the timeslot allocation request packets.

With respect to the timeslot allocation desire check packets given from the node 200A, the node 200D and the node 200E, which newly desire the timeslot allocation, transmit the timeslot allocation request packets to the node 200A within the timeslot allocated to the node 200A. At this time, when the timeslot allocation request packets are simultaneously transmitted from the node 200D and the node 200E, the node 200A can not receive the timeslot allocation request packets from both of these nodes.

In this case, the node 200A does not, even when standing by for the predetermined time, receive the timeslot allocation request packet and does not therefore transmit any new timeslot allocation result notification packet.

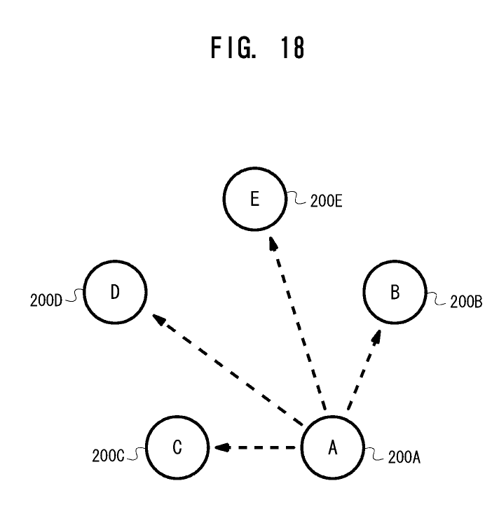

FIG. 18 is a diagram illustrating an example of the state in which the new timeslot allocation result notification packet is not transmitted.

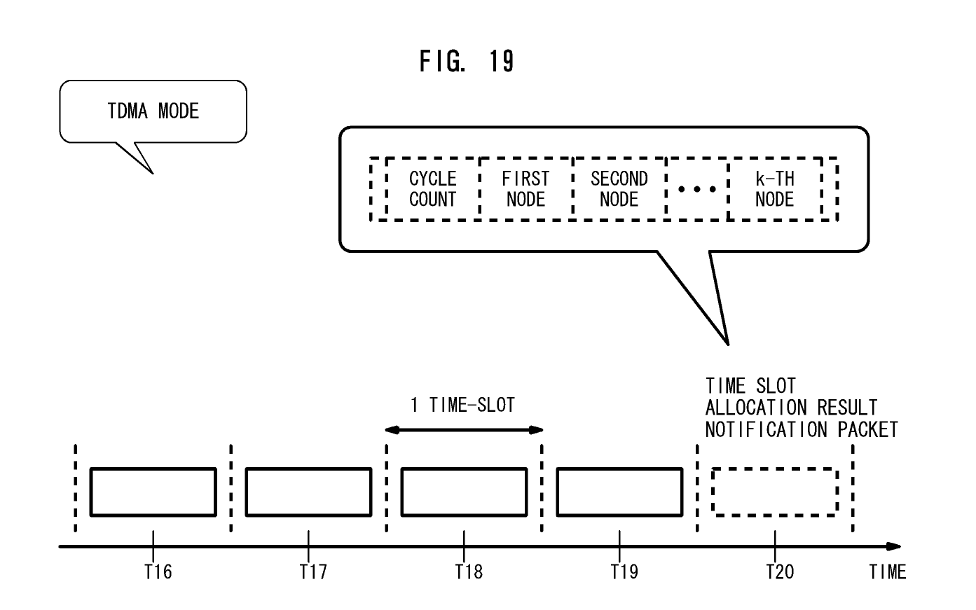

FIG. 19 is a diagram illustrating an example of the timing in the state where the new timeslot allocation result notification packet is not transmitted.

The node 200A can not receive the timeslot allocation request packet till the predetermined time was elapsed since the timeslot allocation desire check packet has been transmitted and does not therefore transmit any new timeslot allocation result notification packet.

The node 200D, which does not receive the timeslot allocation result notification packet, recognizes that the node 200A does not receive the transmitted timeslot allocation request packet. The node 200E similarly recognizes that the node 200A does not receive the transmitted timeslot allocation request packet.

The node 200A defined as the main node, after the elapse of the predetermined time, transmits again the timeslot allocation desire check packets to the peripheral nodes by use of its own timeslot. The main node can transmit the timeslot allocation desire check packets to the peripheral nodes by use of its own timeslot on the per-predetermined-time basis or the per-predetermined-timeslot basis.

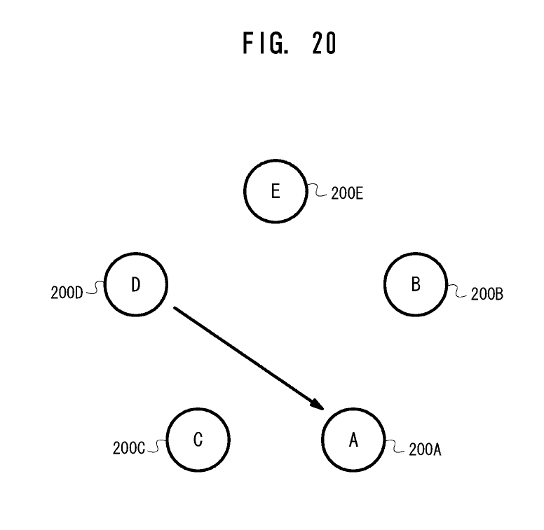

FIG. 20 is a diagram illustrating an example of how the timeslot allocation request packet is retransmitted.

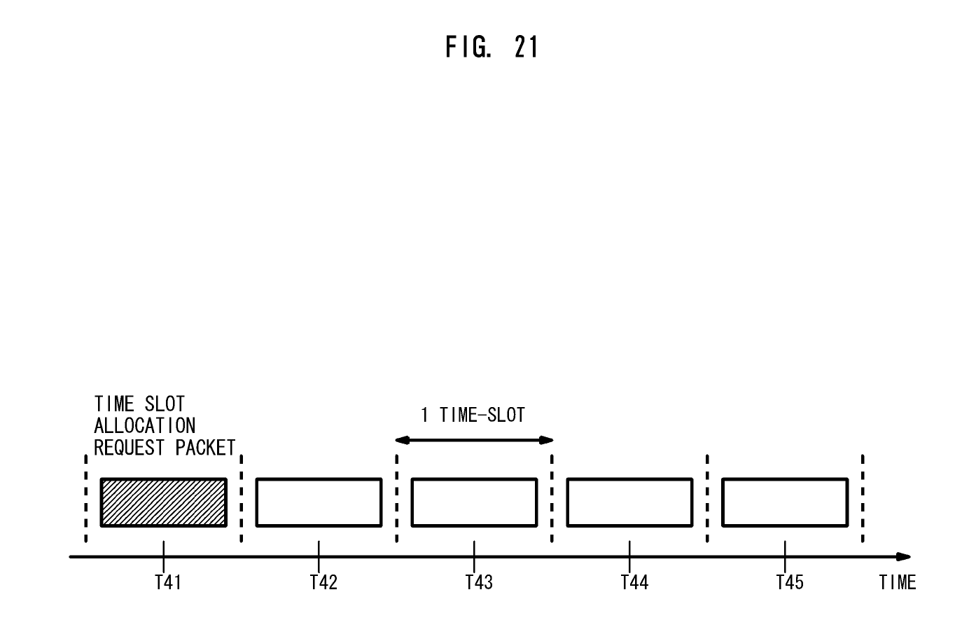

FIG. 21 is a diagram illustrating an example of the transmission timing when the timeslot allocation request packet is retransmitted.

It is assumed that the node 200D receives again the timeslot allocation desire check packet from the node 200A.

The node 200D transmits again the timeslot allocation request packet to the node 200A within the timeslot allocated to the node 200A, which is given after a random period of time has been added to the predetermined time (e.g., at the timing T41). This timeslot allocation request packet does not collide with other packets, and hence the node 200A can receive the timeslot allocation request packet from the node 200D.

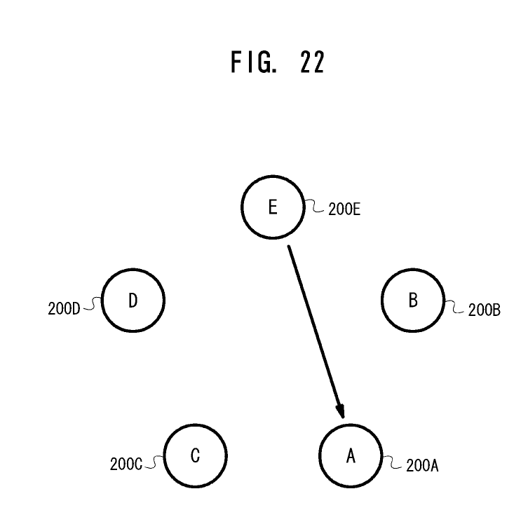

FIG. 22 is a diagram illustrating an example of how the timeslot allocation request packet is retransmitted.

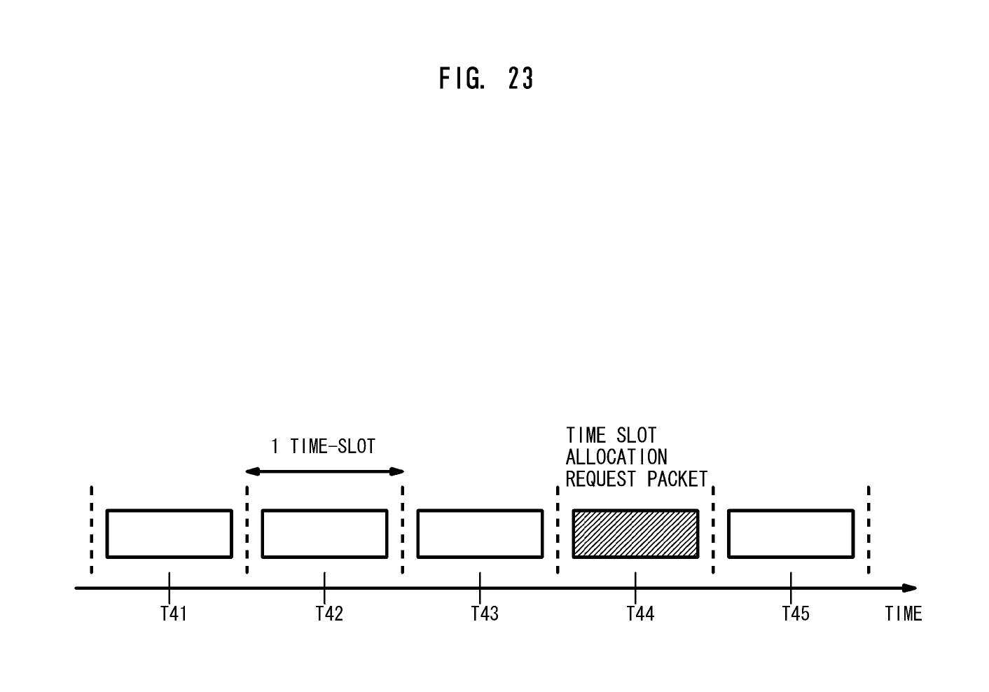

FIG. 23 is a diagram illustrating an example of the transmission timing when the timeslot allocation request packet is retransmitted.

It is assumed that the node 200E also receives again the timeslot allocation desire check packet from the node 200A.

The node 200E also transmits again the timeslot allocation request packet to the node 200A within the timeslot allocated to the node 200A, which is given after a random period of time has been added to the predetermined time (e.g., at the timing T44). This timeslot allocation request packet does not collide with other packets, and therefore the node 200A can receive the timeslot allocation request packet from the node 200E.

The node 200A can recognize that the node 200D and the node 200E have the desire for the new timeslot allocation.

The node 200A allocates the timeslots on the basis of the timeslot allocation request packets. The main node allocates the timeslot to the self-node. Further, the main node allocates the timeslots to the nodes that have already been in the process of the communications in the TDMA mode. Herein, the timeslots are allocated to the five nodes, i.e., the node 200A, the node 200B, the node 200C, the node 200D and the node 200E. An available scheme is, however, that the timeslots are not allocated to the nodes which do not currently perform the communications.

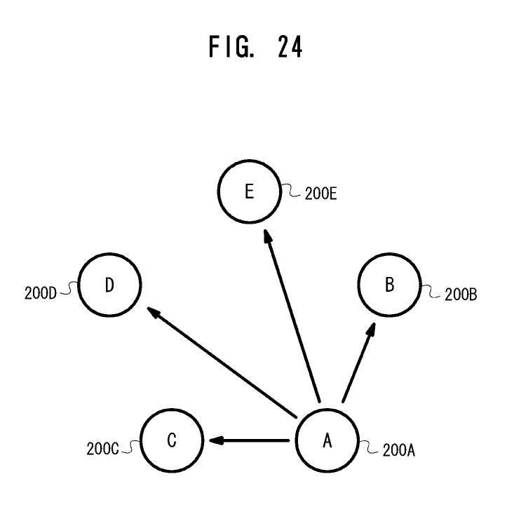

FIG. 24 is a diagram illustrating an example of how the timeslot allocation result notification packet is transmitted.

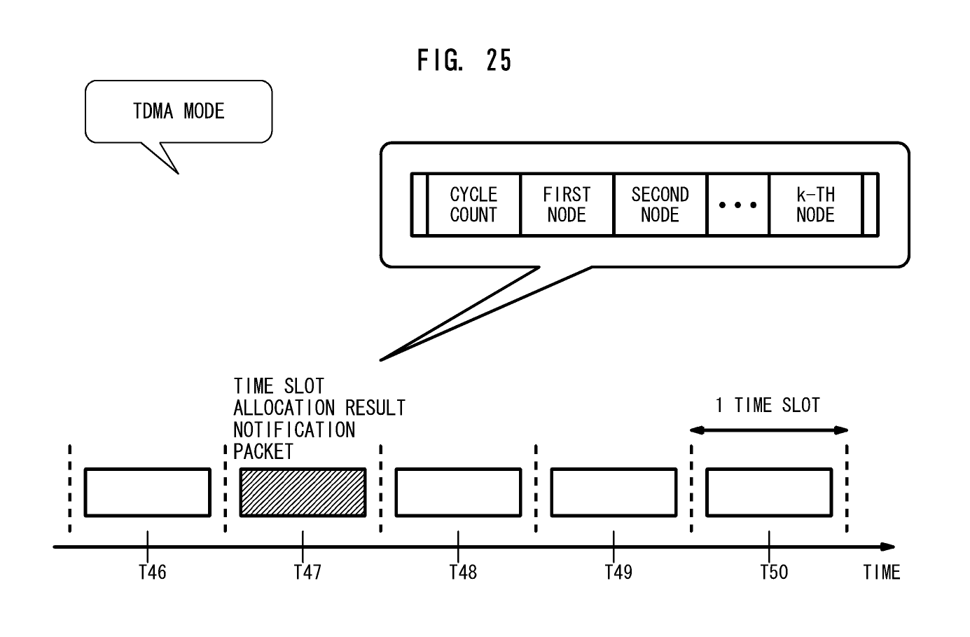

FIG. 25 is a diagram illustrating an example of the transmission timing of the timeslot allocation result notification packet.

Herein, the cycle count is [5] because of the timeslots being shared among the node 200A, the node 200B, the node 200C, the node 200D and the node 200E. Further, the timeslots are allocated in the sequence such as the node 200A, the node 200B, the node 200C, the node 200D and the node 200E, and hence the node names are described, in which [A] is given to the first node, [B] is given to the second node, [C] is given to the third node, [D] is given to the fourth node, and [E] is given to the fifth node in this sequence.

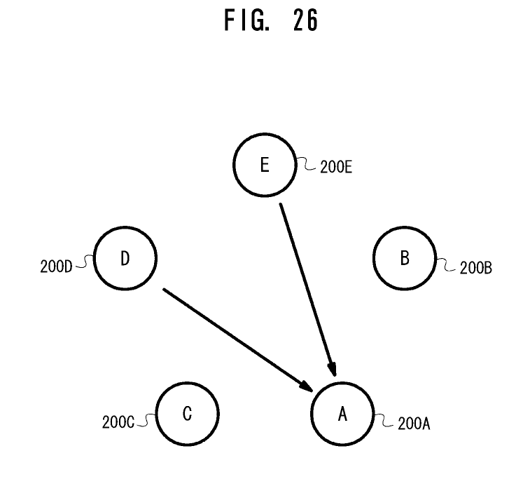

FIG. 26 is a diagram depicting an example when the timeslot allocation request packets are again transmitted simultaneously.

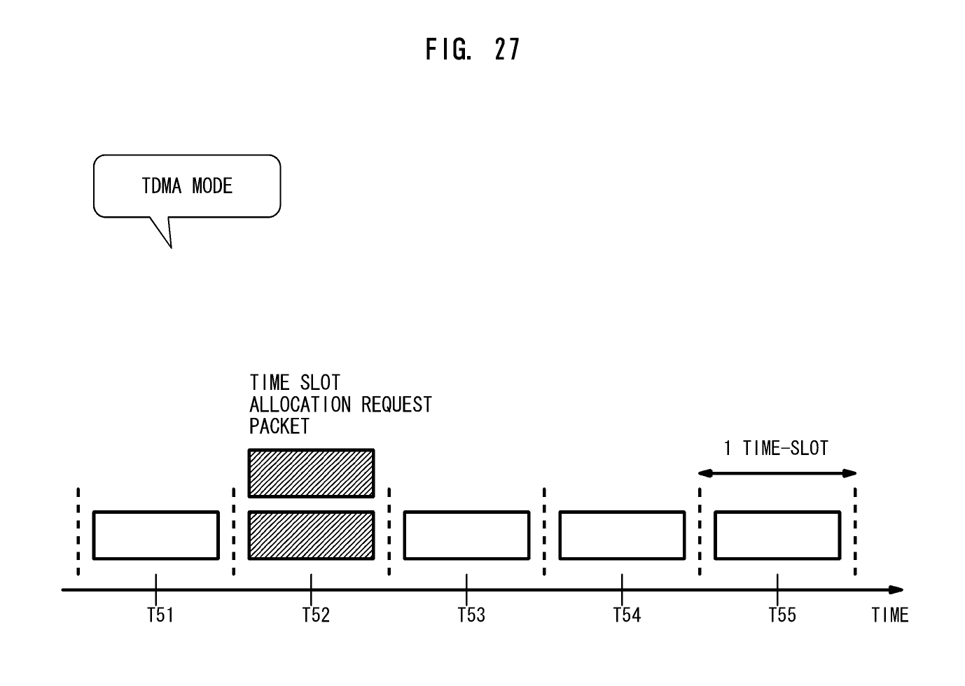

FIG. 27 is a diagram illustrating an example of the transmission timing when the timeslot allocation request packets are again transmitted simultaneously.

When the node 200D and the node 200E transmit again the timeslot allocation request packets within the timeslot allocated to the node 200A and if the timeslot allocation request packets are simultaneously transmitted from the node 200D and the node 200E, the node 200A can not receive the timeslot allocation request packets from both of these nodes.

Then, similarly to the example of FIG. 18, the node 200A defined as the main node does not transmit the new timeslot allocation result notification packet.

The node 200D and the node 200E receiving none of the timeslot allocation result notification packets recognize that the node 200A does not receive the transmitted timeslot allocation request packets.

Thus, if an event of being unable to receive the new timeslot allocation result notification packet continues a predetermined number of times despite the transmission of the timeslot allocation request packet, each of the node 200D and the node 200E transmits, to the node 200A, the packet (back-off count threshold value excess notification packet) which requests the transition to the CSMA/CA mode from the TDMA mode.

The node 200A receiving this packet notifies the peripheral nodes of the transition to the CSMA/CA mode from the TDMA mode. The main node and the peripheral nodes performing the communications with the main node in the TDMA mode transition to the CSMA/CA mode from the TDMA mode.

With this transition, the main node newly transmits the timeslot allocation desire check packets to the peripheral nodes in the CSMA/CA mode.

### <Operation of Node>

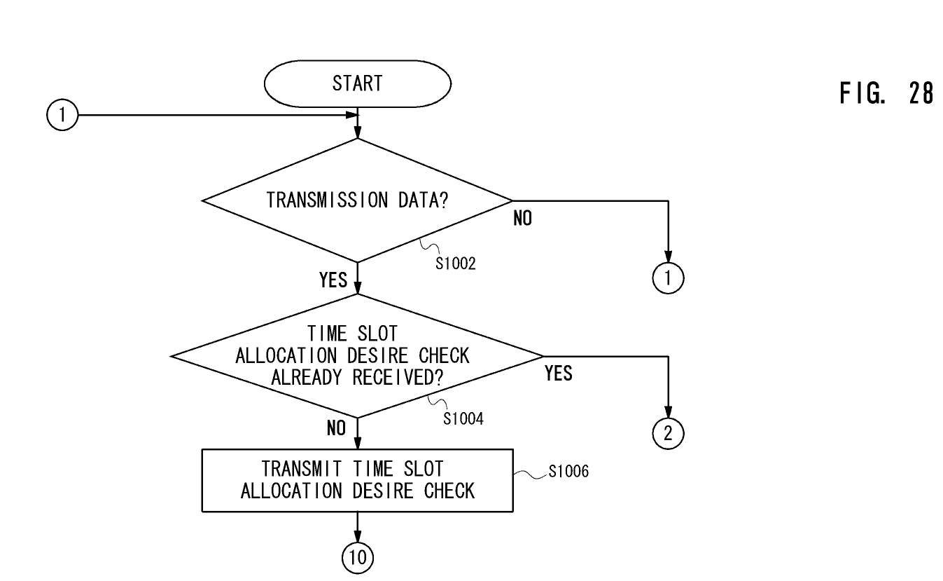

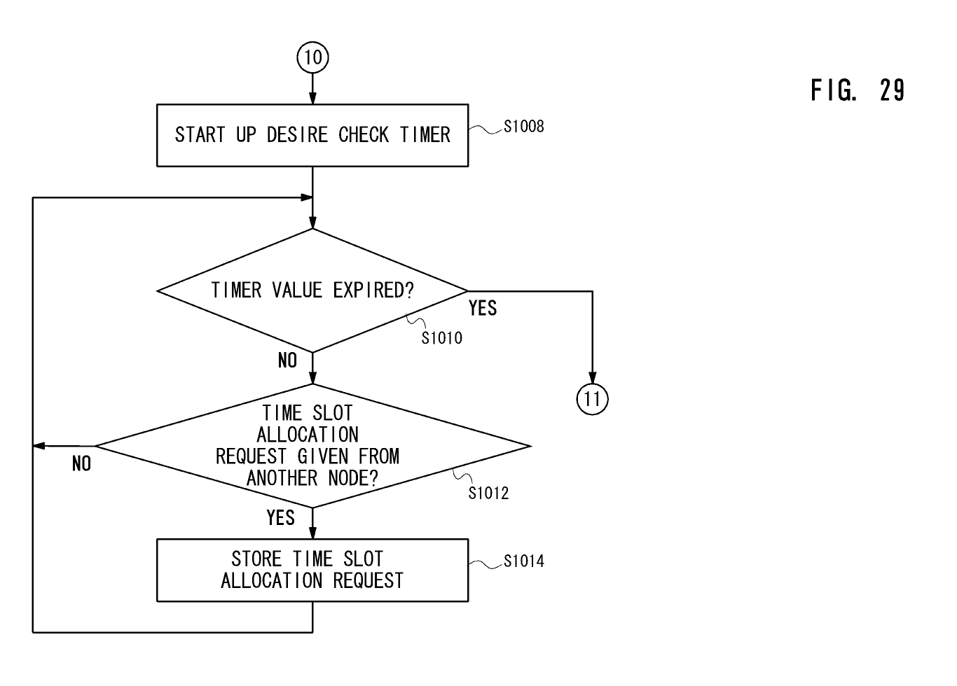

FIGS. 28 through 39 are diagrams depicting operation flowcharts of the individual wireless communication terminal device (node) in the embodiment.

An initial status of the node 200 is the CSMA/CA mode. This is because the communications can not be conducted in the TDMA mode due to the timeslots being unallocated.

The node 200 checks whether there is the data to be transmitted or not (FIG. 28: S1002). If there is no data to be transmitted (S1002; NO), the node 200 stands by till the data for transmission is generated.

Whereas if there is the data to be transmitted (S1002; YES), the node 200 checks whether the timeslot allocation desire check packet has already been received or not (FIG. 28: S1004).

If the timeslot allocation desire check packet is not received (S1004; NO), the node 200 transmits the timeslot allocation desire check packets to the peripheral nodes (FIG. 28: S1006). The node, which transmits the timeslot allocation desire check packet, is called the main node.

The node 200 starts up a desire check timer (FIG. 29: S1008). The desire check timer is a timer which measures a period of time of standing by for a response with respect to the timeslot allocation desire check packet. The time of standing by for the response with respect to the timeslot allocation desire check packet can be set beforehand.

The node 200 determines whether the desire check timer reaches the predetermined time or not (FIG. 29: S1010).

If the desire check timer does not yet reach the predetermined time (S1010; NO), the node 200 checks whether the timeslot allocation request packet is received from another node or not (FIG. 29: S1012).

If the timeslot allocation request packet is received from another node (S1012; YES), the node 200 stores the (node name of) another node as the node desiring the timeslot allocation in the storage device 226 (FIG. 29: S1014) and loops back to step S1010.

Whereas if the timeslot allocation request packet is not received from another node (S1012; NO), the node 200 loops back to step S1010.

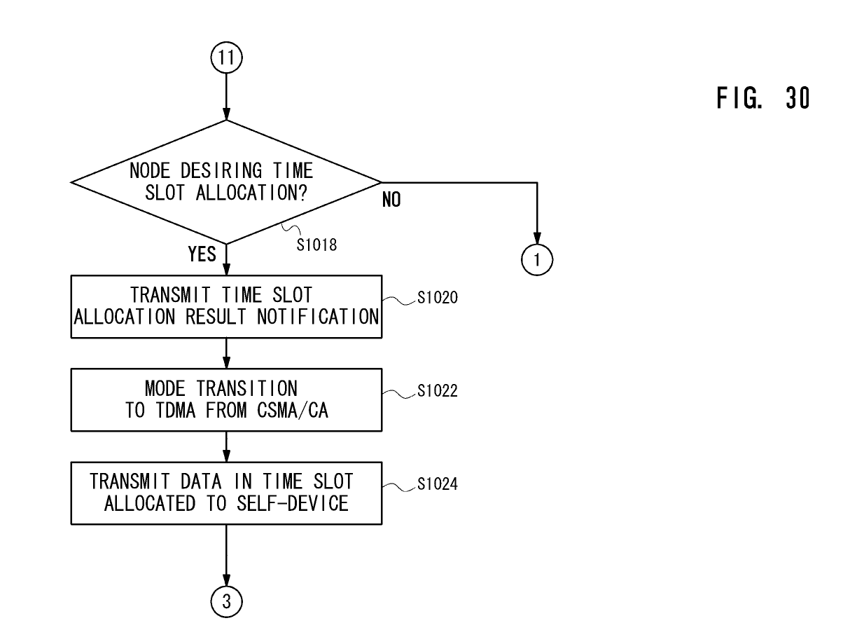

If the desire check timer reaches the predetermined time (S1010; YES), the node 200 checks whether the timeslot allocation desire packet is received or not (FIG. 30: S1018).

If the timeslot allocation desire packet is received (S1018; YES), the node 200 extracts, from the storage device 226, the information on the node desiring the timeslot allocation, which is stored in the storage device 226, and allocates the timeslot. The node 200 transmits the timeslot allocation result notification packets to the peripheral nodes (FIG. 30: S1020). Whereas if the timeslot allocation desire packet is not received (S1018; NO), the node 200 loops back to step S1002.

The node 200 serving as the main node makes the self-device (self-node) transition to the TDMA mode from the CSMA/CA mode (FIG. 30: S1022). With this transition, the main node can conduct the communications with the timeslot-allocated node in the TDMA mode.

The node 200 transmits the data in the timeslot allocated to the self-device (FIG. 30; S1024).

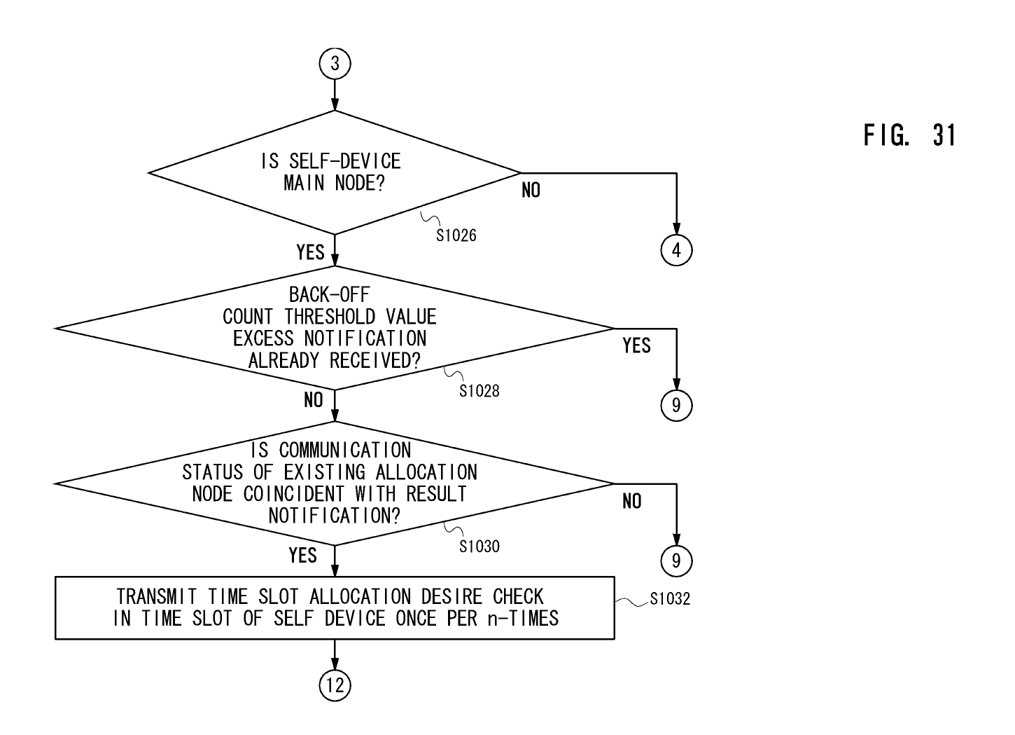

If the self-device is the main node (FIG. 31: S1026; YES), the node 200 checks whether or not the back-off count threshold value excess notification packet is received, which will be described later on.

If the back-off count threshold value excess notification packet is not received (FIG. 31: S1028; NO), the main node checks whether the communication through the allocated timeslot is coincident with the actual communication status or not (FIG. 31: S1030). The main node can check whether or not there exists a withdrawal node which cancels the communications by monitoring the communication status. The main node, if the withdrawal node exists, reallocates the timeslots in a way that excludes the withdrawal node, thereby enabling the communication band to be utilized effectively.

If the communication through the allocated timeslot is coincident with the actual communication status (FIG. 31: S1028; YES), the node 200 transmits the timeslot allocation desire check packet within the timeslot of the self-device (FIG. 31: S1032). The main node can transmit this timeslot allocation desire check packet not every time in the timeslot cyclically allocated to the main node but on the per-timeslot basis. Furthermore, the main node may transmit the timeslot allocation desire check packet on the per-predetermined-time basis.

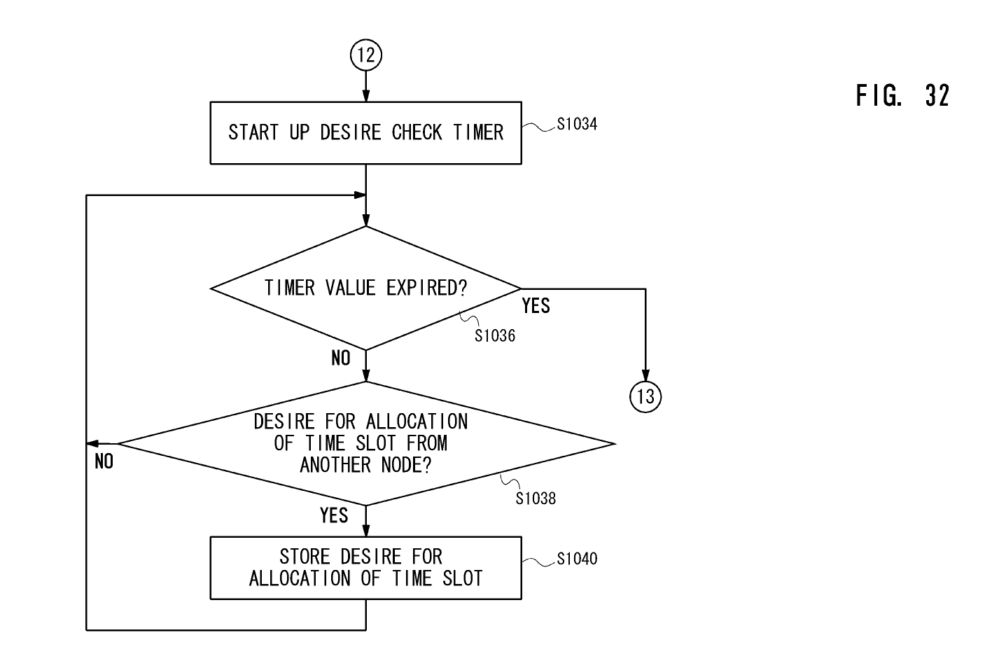

The node 200 starts up a desire check timer (FIG. 32: S1034). The desire check timer is a timer which measures the time of standing by for a response with respect to the desire check packet. The time of standing by for the response with respect to the timeslot allocation desire check packet can be set previously.

The node 200 determines whether the desire check timer reaches the predetermined time or not (FIG. 32: S1036).

If the desire check timer does not yet reach the predetermined time (S1036; NO), the node 200 checks whether the timeslot allocation request packet is received from another node or not (FIG. 32: S1038).

If the timeslot allocation request packet is received from another node (S1038; YES), the node 200 stores another node as the node desiring the timeslot allocation in the storage device 226 (FIG. 32: S1040) and loops back to step S1036.

Whereas if the timeslot allocation request packet is not received from another node (S1038; NO), the node 200 loops back to step S1036.

If the desire check timer reaches the predetermined time (S1036; YES), the node 200 checks whether the timeslot allocation desire packet is received or not (FIG. 3: S1050).

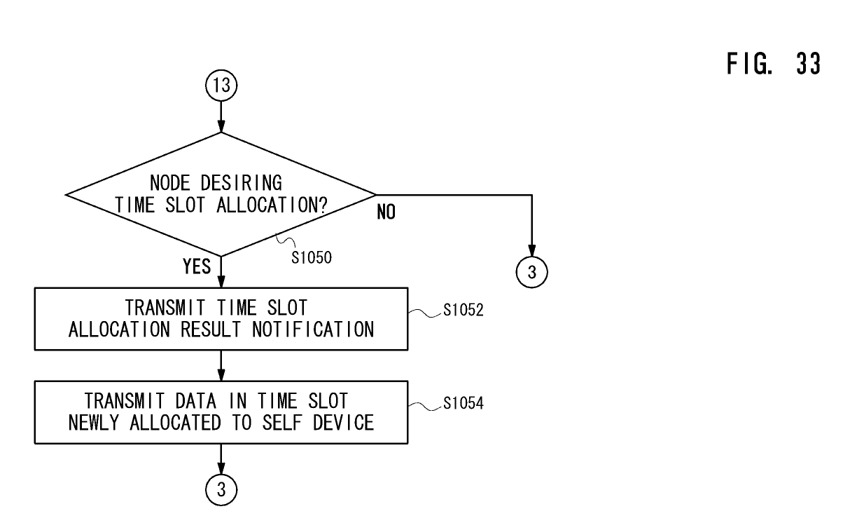

If the timeslot allocation desire packet is received (FIG. 33: S1050; YES), the node 200 extracts, from the storage device 226, the information on the node desiring the timeslot allocation and the information on the node that currently allocates the timeslots, and newly allocates the timeslots to the thus-extracted nodes. The node 200 transmits the timeslot allocation result notification packets to the peripheral nodes (FIG. 33: S1052). Whereas if the timeslot allocation desire packet is not received (S1050; NO), the node 200 loops back to step S1026.

The node 200 transmits the data within the timeslot that is newly allocated to the self-device (FIG. 33: S1054).

What has been discussed so far is the operation flow chiefly when operating as the main node.

Given next is an explanation of an operation flow when operating as the node other than the main node.

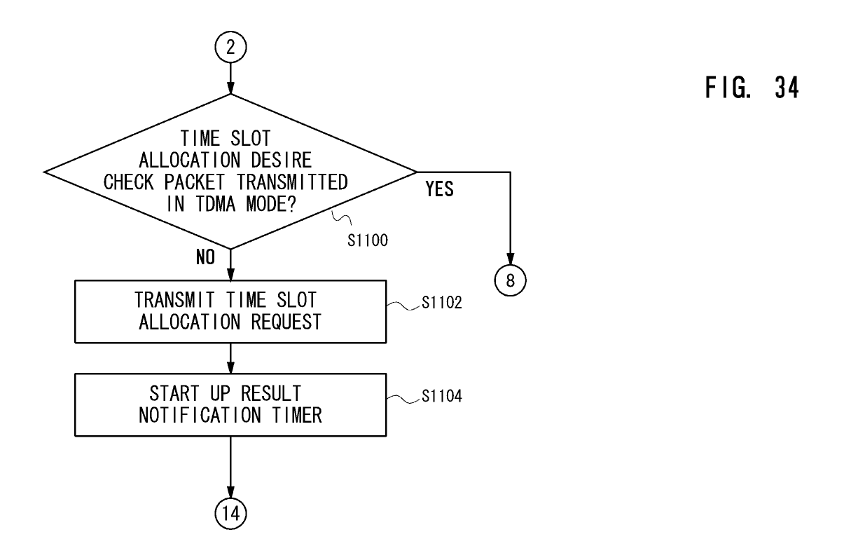

Referring back to FIG. 28, in the case of having the transmission data (S1002; YES) and receiving the timeslot allocation desire check packet (S1004; YES), the node 200 determines whether the timeslot allocation desire check packet is transmitted in the TDMA mode or not (FIG. 34: S1100). The node 200 can determine whether the communications are performed in the TDMA mode or not by monitoring the peripheral communication status. This is because the communications are carried out according to the timeslots in the TDMA mode.

If the timeslot allocation desire check packet is not transmitted in the TDMA mode (S1100; NO), the node 200 transmits the timeslot allocation request packet to the main node which has transmitted the timeslot allocation desire check packet (FIG. 34: S1102). The node 200, which has transmitted to the timeslot allocation request packet, starts up the result notification timer (FIG. 34: S1104). The time of standing by for the response (the timeslot allocation result notification packet) to the timeslot allocation request packet can be set beforehand.

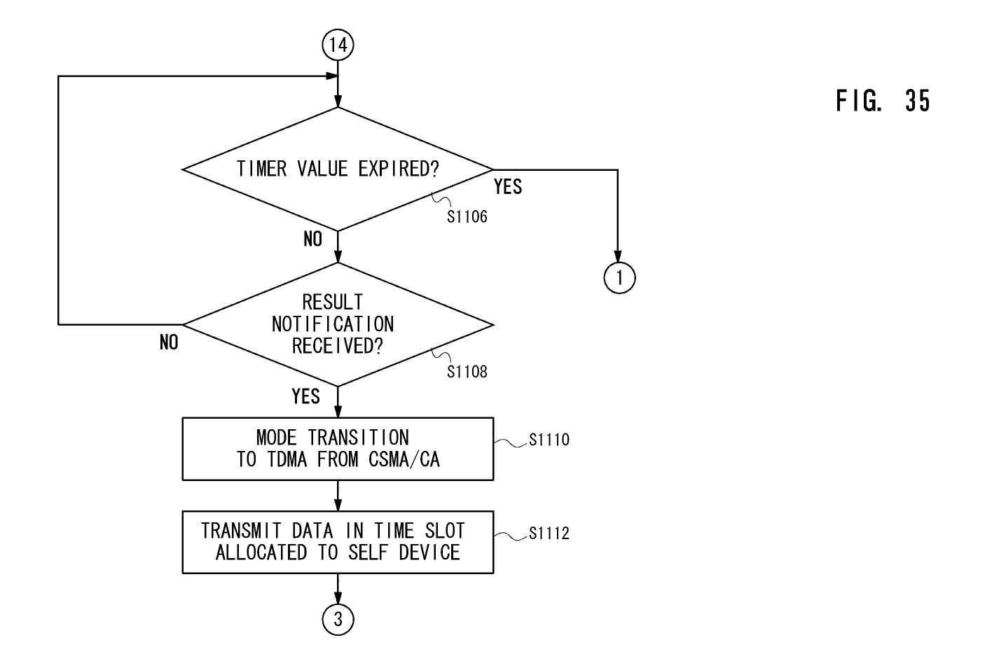

The node 200 determines whether the result notification timer reaches the predetermined time or not (FIG. 35: S1106).

If the result notification timer does not yet reach the predetermined time (S1106; NO), the node 200 checks whether or not the timeslot allocation result notification packet for notifying that the timeslot is allocated to the self-device is received from the main node (FIG. 35: S1108).

The node 200, when receiving the timeslot allocation result notification packet for notifying that the timeslot is allocated to the self-device (S1108; YES), transitions to the TDMA mode from the CSMA/CA mode (FIG. 35: S1110). This is because the node 200 having the data to be transmitted performs the communications in the TDMA mode by use of the allocated timeslot.

The node 200 transmits the data within the timeslot allocated to the self-device (FIG. 35: S1112).

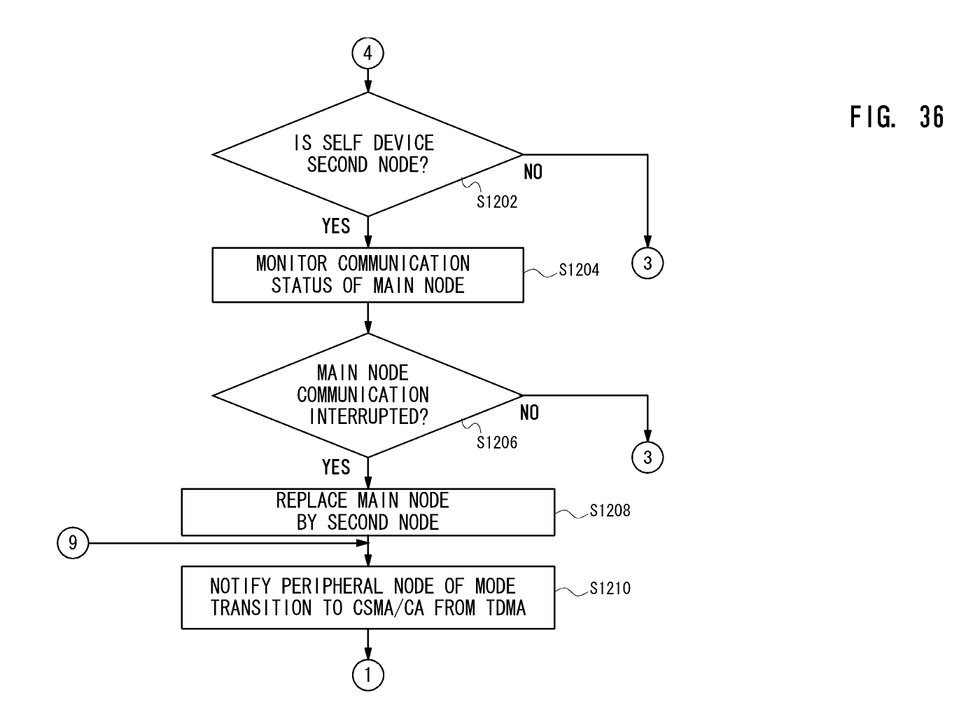

If the self-device is not the main node (FIG. 31: S1026; NO), the node 200 determines whether the self-device is the second node or not (FIG. 36: S1202). The determination as to whether the self-device is the second node or not can be made based on the received timeslot allocation result notification packet. If the timeslot is allocated second to the self-device next to the main node in the timeslot allocation result notification packet, the node 200 can determine that the self-device is the second node. When determining that the self-device is the second node (S1202; YES), the node 200 monitors the communication status of the main node while conducting the communications (FIG. 36: S1204). When determining that the self-device is not the second node (S1202; NO), the node 200 loops back to step S1026.

If the second node determines that the communications of the main node are interrupted (FIG. 36: S1206), the main node is replaced by the second node (FIG. 36: S1208).

The node 200 serving as the main node, in order to newly allocate the timeslots, notifies the peripheral nodes of the transition to the CSMA/CA mode from the TDMA mode (FIG. 36: S1210). The node 200 transitions to the CSMA/CA mode from the TDMA mode. Further, the peripheral nodes receiving this notification similarly transition to the CSMA/CA mode.

Referring back again to FIG. 31, if the node 200 defined as the main node receives the back-off count threshold value excess notification packet (FIG. 31: S1028; YES), or if the node 200 defined as the main node recognizes that the communication status of the existing timeslot-allocated node has a discrepancy from the timeslot allocation result notification packet (FIG. 31: S1030; NO), the node 200 notifies the peripheral nodes of the transition to the CSMA/CA mode from the TDMA mode in order to newly allocate the timeslots (FIG. 36: S1210).

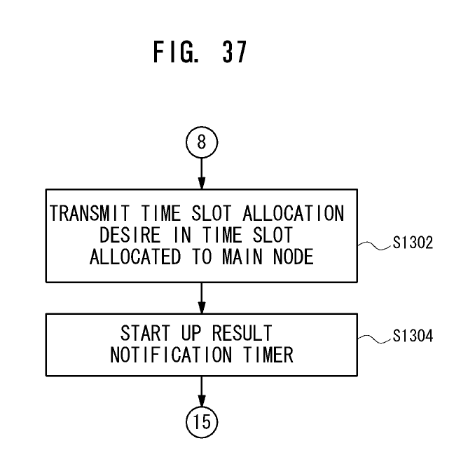

Referring back to FIG. 34, if the timeslot allocation desire check packet is transmitted in the TDMA mode (FIG. 34: S1100; YES), the node 200 transmits the timeslot allocation request packet to the main node, which has transmitted the timeslot allocation desire check packet, in the timeslot allocated to the main node (FIG. 37: S1302). The node 200 transmitting the timeslot allocation request packet starts up the result notification timer (FIG. 37: S1304).

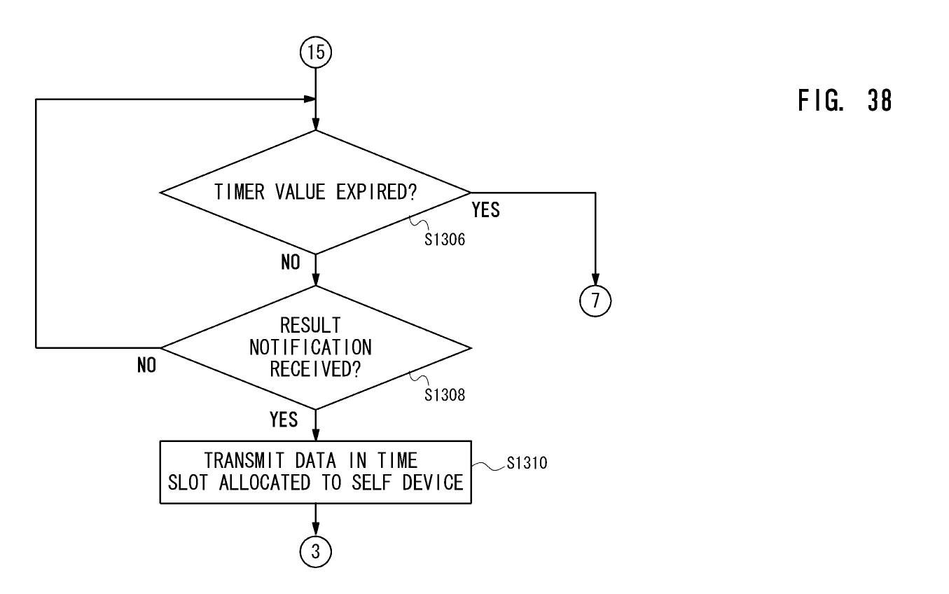

The node 200 determines whether the result notification timer reaches the predetermined time or not (FIG. 38: S1306).

If the result notification timer does not yet reach the predetermined time (S1306; NO), the node 200 checks whether or not the timeslot allocation result notification packet for notifying that the timeslot is allocated to the self-device is received from the main node (FIG. 38: S1308).

The main node, when receiving the timeslot allocation result notification packet for notifying that the timeslot is allocated to the self-device (S1308; YES), transitions to the TDMA mode from the CSMA/CA mode, and transmits the data in the timeslot allocated to the self-device (FIG. 38: S1310).

If the result notification timer reaches the predetermined time (S1306; YES) without receiving the timeslot allocation result notification packet for notifying that the timeslot is allocated to the self-device (S1308; NO), the node 200 recognizes that the main node does not receive the timeslot allocation request packet.

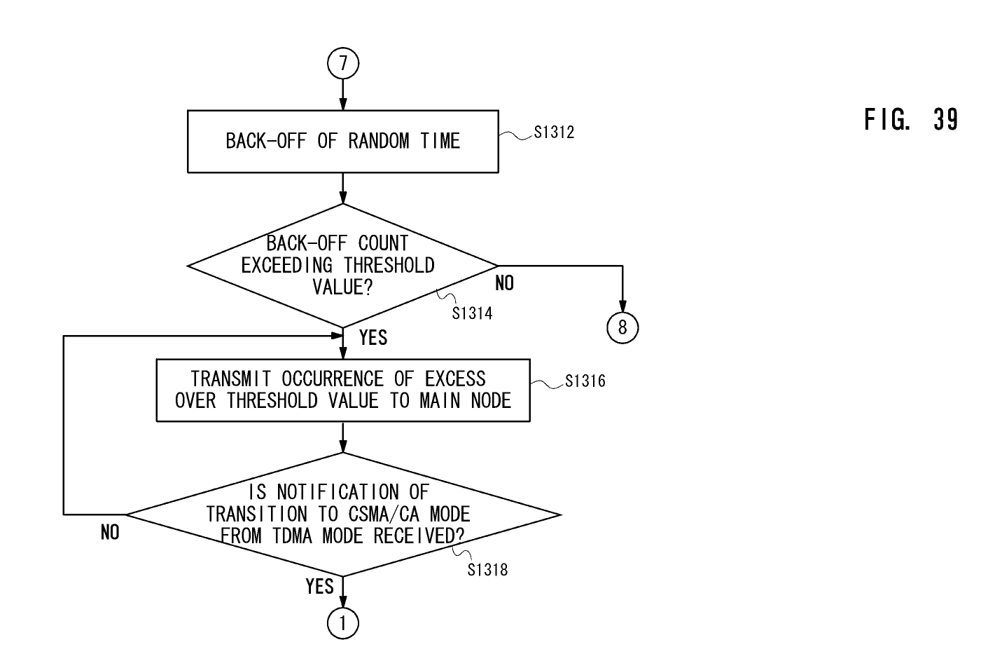

The node 200 executes a back-off process at random time (FIG. 39: S1312). The back-off process implies that the node 200 decides to transmit the timeslot allocation request packet within the timeslot allocated to the main node after an elapse of the predetermined time since the timeslot allocation desire check packet has been received and further after an elapse of the random time. Avoidance of the collision of the timeslot allocation request packet transmitted by the node 200 with the communication packets transmitted by other nodes, is facilitated by adding the random time to the predetermined time.

The node 200 determines whether a back-off process count exceeds a predetermined threshold value or not (FIG. 39: S1314). If the back-off process count does not exceed the predetermined threshold value (S1314; NO), the node 200 waits for the timeslot allocation desire check packet from the main node and transmits the timeslot allocation request packet in the determined timeslot (FIG. 37: S1302).

If the back-off process count exceeds the predetermined threshold value (S1314; YES), the node 200 transmits the back-off count threshold value excess notification packet to the main node (FIG. 39: S1316). This notification packet is a communication packet for making a request for transmitting the notification of the transition to the CSMA/CA mode from the TDMA mode to the main node.

The execution of the back-off process connotes that the main node does not receive the timeslot allocation request packet. Hence, a large back-off process count implies that the main node does not receive the timeslot allocation request packet many times. A reason why the main node does not receive the timeslot allocation request packet many times is derived, it is considered, from a point that a plurality of nodes transmitting the timeslot allocation request packets exists in the timeslot of the main node. In this case, the allocation of the timeslot to the node desiring the timeslot allocation is facilitated by making the timeslot allocation desire check in the CSMA/CA mode. This is because the transmission time is not restricted by the specified timeslot in the CSMA/CA mode. Then, the node 200 prompts the main node to transition from the TDMA mode to the CSMA/CA mode and conduct the timeslot allocation desire check in the CSMA/CA mode.

The node 200 determines whether the notification packet of the transition to the CSMA/CA mode from the TDMA mode is received or not (FIG. 39: S1318).

If the notification packet of the transition to the CSMA/CA mode from the TDMA mode is not received (S1318; NO), the node 200 transmits again the back-off count threshold value excess notification packet to the main node (S1316).

Whereas if the notification packet of the transition to the CSMA/CA mode from the TDMA mode is received (S1318; YES), the node 200 loops back to step S1002.

### <Linkup of Layers>

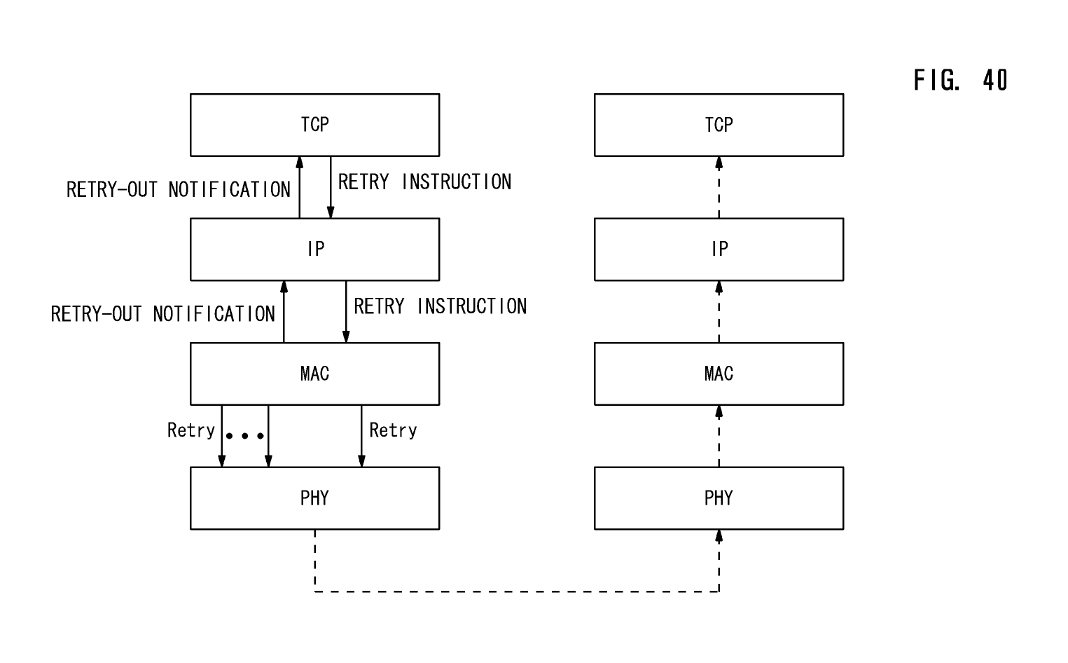

FIG. 40 is a diagram illustrating an example of linkup of layers.

The node 200 serving as the main node allocates the timeslots on the per-predetermined time etc, and can transmit the timeslot allocation result notification packet. An assumption is that this operation temporarily cuts off the communications on a MAC (Media Access Control) layer. At this time, Retry from the MAC layer gets into Retry-out. Then, the MAC layer notifies a high-order layer of the Retry-out. The high-order layer receiving the Retry-out notification and recognizing the cut-off of the communications gives a Retry-instruction to a low-order layer. Thus, even when the communications on the MAC layer are temporarily cut off, the communications can be recovered by the Retry-instruction given from the high-order layer.

It is sufficient that the high-order layer is a layer of a protocol which can guarantee the communication connection. The high-order layer is exemplified by Transmission Control Protocol (TCP), User Datagram Protocol (UDP), etc.

### <Others>

The embodiment can be applied to the communications on the network of the wireless terminals mounted in automobiles traveling on the superhighway and to the communications on the network that is configured emergently when a disaster happens.

### <Operational Effects in Embodiment>

According to the embodiment, the node on the ad hoc network conducts the timeslot allocation desire check in the CSMA/CA mode, and can allocate the timeslot used in the TDMA mode to the node which requests the timeslot allocation. The node, which allocates the timeslot, makes the timeslot allocation desire check during the communications in the TDMA mode, and can allocate the timeslot used in the TDMA mode to the node which newly desires the timeslot allocation.

According to the embodiment, the node conducts the timeslot allocation desire check in the CSMA/CA mode and allocates the timeslot to each node, and the data communications are performed in the TDMA mode, thereby enabling the usage efficiency of the communication band to be enhanced. Further, in the TDMA mode also, the node makes the timeslot allocation desire check and allocates the timeslot to the node which newly desires the participation, thereby enabling this node to participate.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A transmission mode control method executed by a wireless communication device capable of performing wireless communications with other wireless communication devices in a transmission mode where a collision with other transmission signals might occur, the method comprising:
determining whether or not communications according to a timeslot are carried out in response to communication requests collected from a plurality of other wireless communication devices; and
executing a timeslot allocation process according to the collected communication requests when determining that the communications according to the timeslot are carried out, and performing the wireless communications with the other wireless communication devices in the transmission mode when determining that the communications according to the timeslot are not carried out.

2. A communication terminal device comprising:
a receiving unit to receive a packet;
a transmitting unit to transmit the packet;
a signal generating unit to generate a timing signal; and
a processing unit to process the packets transmitted to and received from the other devices,
wherein the transmitting unit transmits a transmission period allocation desire check packet for checking a device which desires allocation of a transmission period for transmitting data,
the receiving unit receives a transmission period allocation request packet with respect to the transmission period allocation desire check packet,
the processing unit allocates, based on the transmission period allocation request packet, the transmission periods to a self-device and other devices which request the allocation of the transmission periods, and generates a transmission period allocation result notification packet for notifying the other devices of a transmission period allocation result,
the transmitting unit transmits the transmission period allocation result notification packet,
the signal generating unit generates a timing signal based on time information, and
the transmitting unit transmits the data in the transmission period allocated to the self-device in a way that synchronizes with the timing signal.

3. A communication terminal device according to claim 2, wherein the processing unit, after the transmitting unit has transmitted the transmission period allocation desire check packet and if the receiving unit does not receive the transmission period allocation request packet with respect to the transmission period allocation desire check packet for a predetermined period of time, instructs the transmitting unit to transmit the transmission period allocation desire check packet.

4. A communication terminal device according to claim 2, wherein the transmission period allocation result notification packet contains identifying information of the device allocated the transmission period and the number of the devices allocated the transmission periods.

5. A communication terminal device according to claim 2, wherein the transmitting unit transmits a transmission period allocation desire check packet for checking the device which desires the allocation of the transmission period in the transmission period allocated to the self-device by using the timing signal,
the receiving unit receives a transmission period allocation request packet with respect to the transmission period allocation desire check packet,
the processing unit allocates, based on the transmission period allocation request packet and the transmission period allocation request packet, the transmission periods to the self-device and the other devices which request the allocation of the transmission periods, and generates a transmission period allocation result notification packet for notifying the other devices of a transmission period allocation result,
the transmitting unit transmits the transmission period allocation result notification packet in the transmission period allocated to the self-device on the basis of the first period allocation result by using the timing signal, and
the transmitting unit transmits the data in the transmission period allocated to the self-device in a way that synchronizes with the timing signal.

6. A communication terminal device according to claim 5, wherein the processing unit, when recognizing another device which does not perform the transmission in the transmission period allocated to the another device on the basis of the transmission period allocation request packet, allocates the transmission periods in a way that excludes the another device, and generates a transmission period allocation result notification packet for notifying the other devices of a transmission period allocation result.

7. A communication terminal device according to claim 2, wherein when the receiving unit receives a packet for requesting a stop of the communications based on the transmission period allocation result from the another device, the communications based on the transmission period allocation result are stopped, and
the transmitting unit transmits again the transmission period allocation desire check packet for checking the device which desires the allocation of the transmission period.

8. A communication terminal device comprising:
a receiving unit to receive a packet;
a transmitting unit to transmit the packet;
a signal generating unit to generate a timing signal; and
a processing unit to process the packets transmitted to and received from the other devices,
wherein the receiving unit receives a transmission period allocation desire check packet for checking a device which desires allocation of a transmission period for transmitting data,
the processing unit, if there is data to be transmitted to another device, generates a transmission period allocation request packet with respect to the transmission period allocation desire check packet,
the transmitting unit transmits a transmission period allocation request packet with respect to the transmission period allocation desire check packet,
the receiving unit receives a transmission period allocation result notification packet with respect to the transmission period allocation request packet,
the signal generating unit generates a timing signal based on time information, and
the transmitting unit transmits the data in the transmission period allocated to the self-device on the basis of the transmission period allocation result notification packet by use of the timing signal.

9. A communication terminal device according to claim 8, wherein after the transmitting unit has transmitted the transmission period allocation request packet with respect to the transmission period allocation desire check packet and if the receiving unit receives the transmission period allocation result notification packet within a predetermined period of time, the signal generating unit generates the timing signal based on the time information, and
the transmitting unit transmits the data in the transmission period allocated to the self-device on the basis of the transmission period allocation result notification packet by use of the timing signal.

10. A communication terminal device according to claim 8, wherein the processing unit, when recognizing that the another device transmitting the transmission period allocation result notification packet does not perform the communications, stops the communications based on the transmission period allocation result notification packet,
the transmitting unit transmits the transmission period allocation desire check packet for checking a device which desires the allocation of the transmission period,
the receiving unit receives the transmission period allocation request packet with respect to the transmission period allocation desire check packet,
the processing unit allocates, based on the transmission period allocation request packet, the transmission periods to the self-device and the other devices which request the allocation of the transmission periods, and generates a transmission period allocation result notification packet for notifying the other devices of a transmission period allocation result,
the transmitting unit transmits the transmission period allocation result notification packet,
the signal generating unit generates a timing signal based on the time information, and
the transmitting unit transmits the data in the transmission period allocated to the self-device in a way that synchronizes with the timing signal.

11. A communication terminal device according to claim 8, wherein the transmission period allocation desire check packet is transmitted by another device in a transmission period allocated to the another device, and
the transmitting unit transmits a transmission period allocation request packet with respect to the transmission period allocation desire check packet in a transmission period allocated to the another device by using a timing signal generated by the signal generating unit based on time information.

12. A communication terminal device according to claim 11, wherein after the transmitting unit has transmitted the transmission period allocation request packet with respect to the transmission period allocation desire check packet, if the receiving unit does not receive the transmission period allocation result notification packet within a predetermined period of time and when the receiving unit receives, from another device, the transmission period allocation desire check packet transmitted in the transmission period allocated to the another device, the processing unit stands by for a random period of time, and
the transmitting unit transmits the transmission period allocation request packet with respect to the transmission period allocation desire check packet in the transmission period allocated to the another device by use of the timing signal.

13. A communication terminal device according to claim 12, wherein the processing unit, when a random time standby count is counted and exceeds a predetermined count, instructs the transmitting unit to transmit a packet for requesting a stop of the communications based on the transmission period allocation result to the another device.

14. A communication terminal device according to claim 11, wherein the processing unit, when recognizing that the another device transmitting the transmission period allocation result notification packet does not perform the communications, stops the communications based on the transmission period allocation result notification packet,
the transmitting unit transmits the transmission period allocation desire check packet for checking a device which desires the allocation of the transmission period,
the receiving unit receives the transmission period allocation request packet with respect to the transmission period allocation desire check packet,
the processing unit allocates, based on the transmission period allocation request packet, the transmission periods to the self-device and the other devices which request the allocation of the transmission periods, and generates a transmission period allocation result notification packet for notifying the other devices of a transmission period allocation result,
the transmitting unit transmits the transmission period allocation result notification packet,
the signal generating unit generates a timing signal based on the time information, and
the transmitting unit transmits the data in the transmission period allocated to the self-device in a way that synchronizes with the timing signal.
